(19) United States
(12) Patent Application Publication
(10) Pub. No.: US 2006/0011883 A1
(43) Pub. Date: Jan. 19, 2006

(54) Threaded polymer valve seat and valve employing same

(76) Inventor: Richard L. Martin, Point Richmond, CA (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/175,178

(22) Filed: Jul. 7, 2005

Related U.S. Application Data
(60) Provisional application No. 60/588,432, filed on Jul. 16, 2004.

(51) Int. Cl. F16K 1/00

(52) U.S. Cl. 251/331

(57) ABSTRACT

A high-pressure gas cylinder valve capable of controlling the flow of gas at operating pressures up to 3000 psig has a movable diaphragm mounted on the valve body to form part of a flow passage through the valve. The diaphragm is movable into and out of sealing engagement with a valve seat surface presented by a threaded polymer valve seat which is screwed into a threaded aperture of the valve body about the flow passage. The polymer valve seat has a larger diameter at one end which presents the valve seat surface and is secured in the threaded aperture by self-locking threads on the valve body. A central opening in the seat is hex shaped so that the seat can be screwed into the valve body.

### RELATED APPLICATION

This application claims priority of U.S. provisional patent application No. 60/588,432, filed Jul. 15, 2004.

### TECHNICAL FIELD

The present invention is directed to an improved polymer valve seat and a high-pressure gas valve, especially a cylinder valve, employing the same.

### BACKGROUND

A cylinder valve typical of most diaphragm cylinder valves currently used is shown in FIG. 1 of the drawings. The cylinder valve 1 comprises a handwheel 2 connected to a threaded valve stem 3 which is rotatably mounted in a bonnet 4. When the handwheel is rotated clockwise, the threaded valve stem moves downwardly to the position shown in the right half of FIG. 1 to press a seat 5 in sealing engagement with a valve body 6 about a gas passage 7 through the valve to stop gas flow through the valve. The force for sealing is transmitted from the lower end of the valve stem 14 to the seat by way of a button 8, a flexible metal diaphragm 9 and spaced piston-like component 10 movably positioned within a bore 12 of the valve body. A force transmitting spring 13 with ends on movable component 10 and fixed component 11 keeps the valve stem in contact with the diaphragm. The seat is carried on the lower end of valve stem 14. This known cylinder valve is somewhat costly to manufacture and assemble. Particle generation associated with the spring can also be problematic when controlling the flow of high purity gas.

In attempts to avoid these shortcomings of the typical cylinder valve of FIG. 1, the assignee of the present application has produced the cylinder valves shown in FIGS. 2 and 3. In the cylinder valve 41 of FIG. 2 a polymer seat 15 is pressed into an aperture of the valve body, as shown in dashed lines, about a flow passage through the valve. A flexible metal diaphragm 16 is moved into and out of sealing engagement with the valve seat for closing and opening the valve. Rotation of the threaded valve stem 17 with the handwheel, shown in dashed lines, results in translation of the valve stem in the valve along the axis A-A. A piston 18 movably mounted in a bore 19 of a cap 20 of the valve transmits force between the lower end of the valve stem and the diaphragm. This arrangement works well provided the operating pressure of the gas whose flow is being controlled is less than about 250 pounds per square inch gauge (hereinafter psig). If subjected to higher pressures the seat may pull out upon opening the valve.

The cylinder valve 21 depicted in FIG. 3 has a similar construction to that in FIG. 2 but uses a polymer seat 22 that is crimped into the valve body 23. The seat has a larger diameter at its base or lower end, which is installed in an upwardly open, annular aperture 24 in the valve body about gas passage 25 extending through the valve. A hand press fixture, not shown, is used for seat installation, if necessary, to fully insert the seat into the aperture. Once installed, the valve body with seat is loaded into a press and, using a crimp fixture, a load of 4000 pounds is applied to crimp the valve body about the seat to secure it. The crimped seat is then inspected for burrs. The polymer seat will not pull out of the valve body at operating pressures up to 3000 psig provided it is properly crimped. In this regard, it is difficult to determine whether the crimp is properly executed. If over crimped, the seat may craze due to the high stresses. If under crimped, the seat may pull out upon valve opening. Metal slivers may also be generated during the crimping operation as the crimping tool wears.

### SUMMARY

The present invention is an improved high-pressure gas cylinder valve which avoids the aforementioned problems and disadvantages of the known cylinder valves. To this end, a cylinder valve of the invention for controlling the flow of gas from a gas cylinder, comprises a valve body having a passage extending therethrough for conveying gas from a gas cylinder through the cylinder valve, and a threaded aperture about the passage. A threaded polymer valve seat is screwed into the threaded aperture of the valve body and presents a valve seat surface extending around the passage. A movable diaphragm is mounted on the valve body to form part of the passage. The diaphragm is movable into and out of sealing engagement with the valve seat surface for closing and opening the passage.

The threaded polymer valve seat in the disclosed embodiment is an annular member having a central opening about a longitudinal axis of the valve seat. The opening has a polygonal cross section, preferably hexagonal, to facilitate screwing the valve seat into and out of the threaded aperture in the valve body. Self-locking threads are provided in the threaded aperture of the valve body for retaining the valve seat. The member has a larger diameter at one end to form a shoulder above the self-locking threads. The shoulder provides the valve seat surface about the opening for engaging the diaphragm during valve closure. In the example embodiment the member has a length in the direction of the longitudinal axis which is greater than the diameter of the member.

The cylinder valve with valve seat of the invention has improved reliability in high-pressure gas service. By eliminating a spring, particle generation associated with a spring is avoided, the valve has less dead volume, more flow capacity, is more compact, and less costly to manufacture and assemble. The valve seat in the valve can also be easily replaced and crimping is eliminated.

These and other features and advantage of the present invention will become more apparent from the following detailed description of a disclosed, preferred embodiment of the invention taken with the accompanying drawings.

### BRIEF DESCRIPTION OF DRAWINGS

FIG. 1 is a cross sectional view along a longitudinal axis B-B of a typical prior art diaphragm cylinder valve currently used, the left half of the drawing showing the valve open and the right half depicting the valve closed.

FIG. 2 is a cross sectional view along a longitudinal axis A-A of a prior art cylinder valve, shown partially in dashed lines, employing a polymer seat which is pressed into the valve body.

FIG. 3 is an enlarged cross-sectional view along a longitudinal axis C-C of a portion of another prior art cylinder valve similar to the valve in FIG. 2 but employing a polymer seat which is crimped onto the valve body.

FIG. 4 is a cross sectional view along a longitudinal axis D-D of a cylinder valve of the invention, the left half of the drawing showing the valve open and the right half showing the valve closed, the valve including a threaded polymer valve seat of the invention.

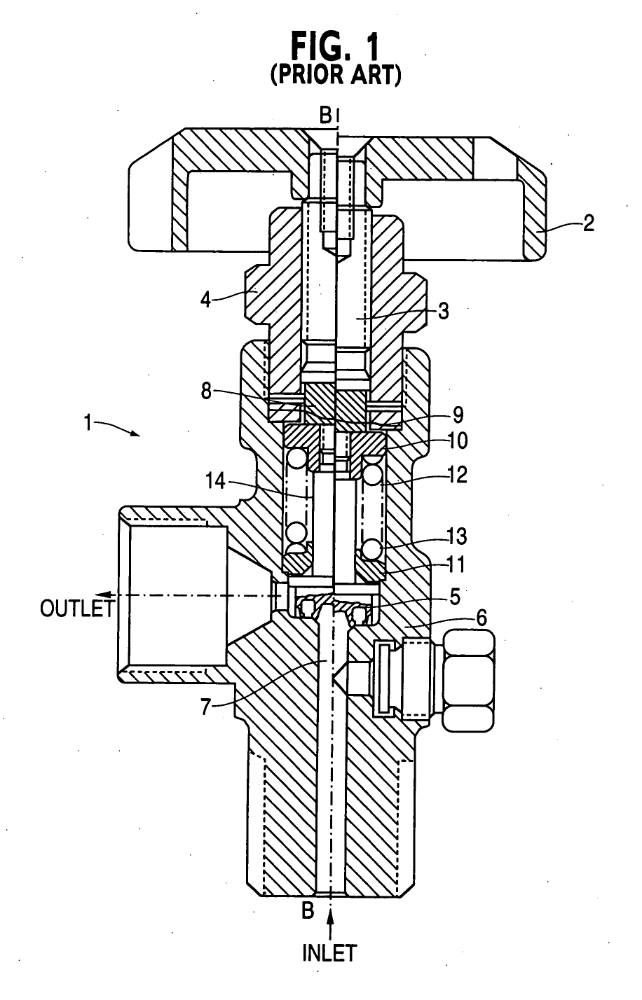

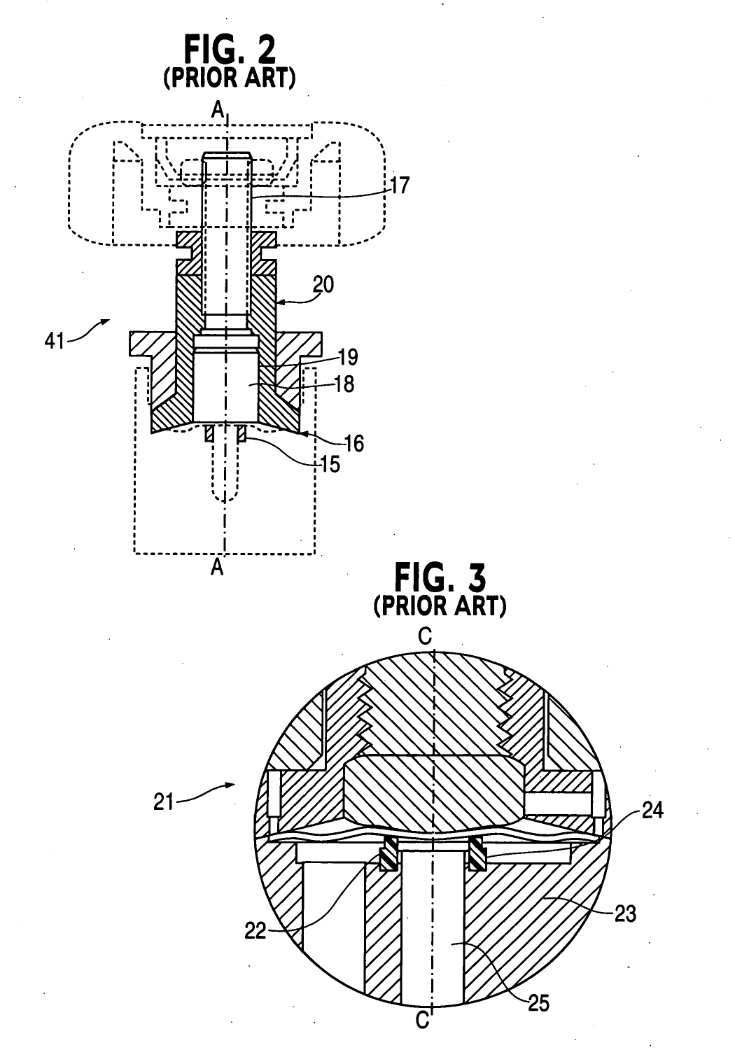

### DETAILED DESCRIPTION

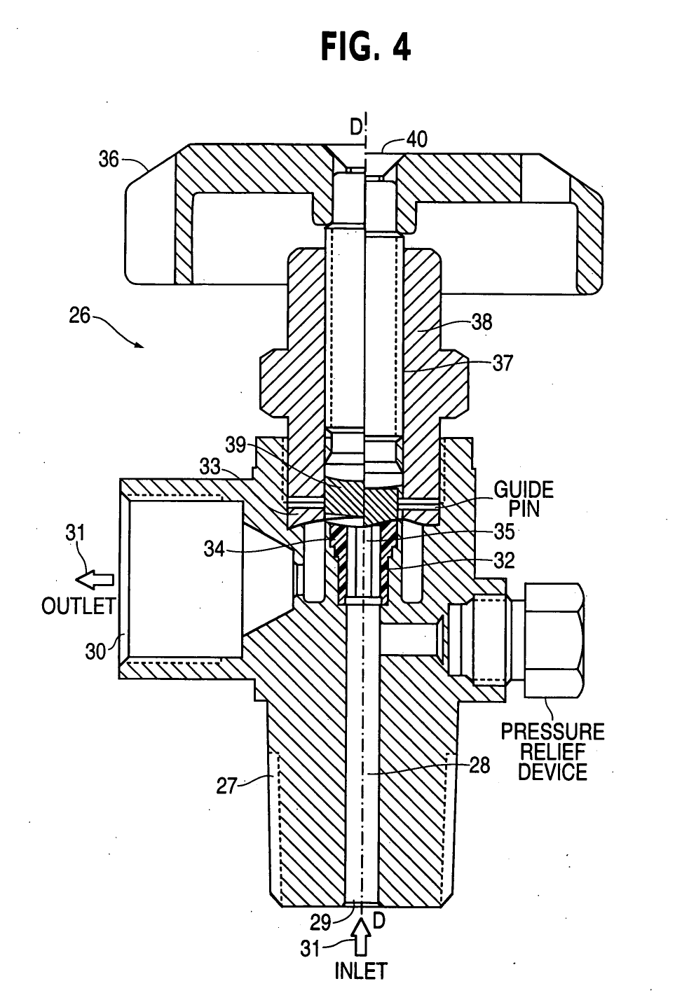

Referring now to FIG. 4 of the drawings, a high-pressure gas cylinder valve 26 of the invention for controlling the flow of gas from a gas cylinder, comprises a valve body 27 having a passage 28 extending therethrough between an inlet 29 and an outlet 30 for conveying gas from the gas cylinder, not shown, through the valve in the direction of arrows 31 in the drawing. A threaded aperture 32 is provided in the valve body about the passage opposite a flexible metal diaphragm 33 of the valve. The diaphragm forms part of the passage when the valve is open and its central portion is movable along the axis D-D to close the passage when seated against a valve seat surface of a threaded polymer valve seat 34 of the invention.

The valve seat 34 is screwed into the threaded aperture 32 and its upper surface serves as the valve seat surface extending around the passage 28 for sealing engagement with the diaphragm when the valve is closed. The threads on the interior of the valve body are self-locking threads so that the seat will not easily loosen in service. The valve seat is an annular member having a central opening 35 therethrough about the central longitudinal axis D-D of the valve seat. The opening forms part of the passage 28. In the example embodiment the annular member is elongated in the direction of the longitudinal axis with the length of the valve seat being greater than the diameter. The central opening 35 is polygonal in cross section, e.g., preferably hex shaped, to facilitate screwing the valve seat into and out of the threaded aperture in the valve body.

The upper end of the valve seat has a larger diameter which forms a shoulder above the remaining externally threaded member below the shoulder. The shoulder presents the valve seat surface for engaging the diaphragm. The lower surface of the shoulder is tapered and engages a complimentary shaped side wall of the opening of the threaded aperture in the valve body.

The high-pressure gas cylinder valve 26 is a manual valve with a handwheel 36 secured by way of a metal screw 40 and a splined connection to a threaded valve stem 37. When the handwheel is rotated clockwise the threaded stem moves toward the seat in its surrounding bonnet 38 which is mounted on the top of the valve body. The lower end of the stem contacts a button 39 that contacts and deflects the domed diaphragm toward the seat. When the diaphragm contacts the seat with sufficient force the flow path is sealed as shown on the right side of the drawing. The diaphragm can be formed of a single flexible metal layer or, preferably, several flexible metal layers layered on one another. The diaphragm is clamped by the bonnet against the valve body around its outer periphery to form part of the passage 28 as shown in FIG. 4.

When the handwheel is rotated counterclockwise, the threaded stem moves away form the seat. As the stem moves away from the seat, the metal diaphragm is unrestrained and pushes on the button with sufficient force so that the button continues to contact and move with the stem. When the stem makes contact with an internal stop located in the bonnet, the flow path is fully open as shown on the left side of the drawing.

In the example embodiment the threaded polymer valve seat 34 is machined from a fluorocarbon polymer, PCTFE bar, but other polymers and manufacturing techniques could be used as will be apparent to the skilled artisan. The length of the valve seat along its longitudinal axis D-D in the embodiment is 0.45 inch, while the outer diameter of the larger, upper end or shoulder is 0.36 inch. The width between opposing faces of the hex-shaped central opening of the seat is 0.156 inch. The threads are 5/16-24 UNF and the corresponding self-locking threads in the threaded aperture of the metal valve body are 5/16-24 3F. Of course, other dimensions and shapes or thread sizes for the valve seat and the threaded aperture could be used as will be understood by the skilled artisan.

From the above, it can be seen that the cylinder valve of the invention with its threaded polymer valve seat offers the advantage that the cylinder valve can be used in high pressure(operating pressure up to 3000 psig) gas service without the valve seat being pulled out on opening. Crimping is eliminated and the cylinder valve has improved reliability. The valve seat can be easily replaced, and is economical to make and install. Particle generation associated with a spring is also eliminated and compared with the typical cylinder valve, the cylinder valve of the invention is less costly to manufacture and assemble, has less dead volume, has more flow capacity, and is more compact.

While I have shown and described only one embodiment in accordance with the present invention, the invention is not limited to the details thereof as shown and described herein but is susceptible to the numerous variations and will be readily understood by the skilled artisan without departing from the spirit of the invention or the scope of the following claims.

I claim:

1. A cylinder valve for controlling the flow of gas from a gas cylinder, comprising:
a valve body having a passage extending therethrough for conveying gas from a gas cylinder through the cylinder valve, and a threaded aperture about said passage;
a threaded polymer valve seat which is screwed into said threaded aperture of said valve body and presents a valve seat surface extending around said passage;
a movable diaphragm mounted on the valve body to form part of said passage opposite said valve seat surface, said diaphragm being movable into and out of sealing engagement with said valve seat surface for closing and opening said passage.

2. The cylinder valve according to claim 1, wherein said threaded polymer valve seat has threads thereon which are engaged with self-locking threads of said threaded aperture in said valve body.

3. The cylinder valve according to claim 1, wherein said threaded polymer valve seat is an annular member having a central opening therethrough about along a longitudinal axis of the valve seat, external threads being provided on the annular member engaging threads of said threaded aperture of said valve body, and said annular member being elongated in the direction of said longitudinal axis.

4. The cylinder valve according to claim 3, wherein the length of said annular member in the direction of said longitudinal axis is greater than the diameter of said annular member.

5. The cylinder valve according to claim 3, wherein said central opening of said annular member has a polygon cross section to facilitate screwing the valve seat into and out of said threaded aperture in the valve body.

6. The cylinder valve according to claim 3, wherein said valve seat surface is presented at one end of said annular member around said opening, said one end of the annular member having a larger diameter than the remaining, externally threaded member to form a shoulder on said valve seat which engages a complimentarily shaped side wall at the entrance of said threaded aperture of said valve body.

7. The cylinder valve according to claim 1, further comprising a threaded valve stem rotatably mounted in said valve to move the diaphragm into and out of sealing engagement with said valve seat surface for opening and closing said passage.

8. The cylinder valve according to claim 7, further comprising a button intermediate an end of said valve stem and said diaphragm for engaging said diaphragm on a side of said diaphragm opposite the side of the diaphragm engaging said valve seat.

9. The cylinder valve according to claim 7, further comprising a handwheel connected to said valve stem for rotating the valve stem to open and close the valve.

10. The cylinder valve according to claim 1, wherein said movable diaphragm is formed of at least one layer of metal.

11. The cylinder valve according to claim 1, wherein said valve body has a threaded end about an inlet of said passage, said threaded end being directly connectable to a gas cylinder.

12. The cylinder valve according to claim 1, wherein said valve is a high-pressure gas cylinder valve capable of controlling the flow of gas at operating pressures up to 3,000 pounds per square inch.

13. A valve seat for a valve to control the flow of high-pressure gas, comprising:
a polymer, annular member having a central opening therethrough about a longitudinal axis of the member;
the member having a larger diameter at one end to form a shoulder presenting a valve seat surface around said opening;
threads provided on the exterior of the polymer, annular member below said shoulder for screwing the valve seat into self-locking threads about an aperture in a valve body;
wherein said central opening has a polygonal cross section to facilitate screwing the valve seat into and out of a threaded aperture in a valve body.

14. The valve seat according to claim 13, wherein said member has a length in the direction of said longitudinal axis which is greater than a diameter of said annular member.

15. A valve for controlling the flow of high-pressure gas, comprising:
a valve body having a passage extending therethrough for conveying gas through the valve, and a threaded aperture about said passage;
a threaded polymer valve seat which is screwed into said threaded aperture of said valve body and presents a valve seat surface extending around said passage;
a movable diaphragm mounted on the valve body to form part of said passage opposite said valve seat surface, said diaphragm being movable into and out of sealing engagement with said valve seat surface for closing and opening said passage;
a valve stem which is movably mounted in the valve to move the diaphragm into and out of sealing engagement with said valve seat surface;
wherein said valve seat has a central opening therethrough about a longitudinal axis of the valve seat, the central opening having a polygoral cross section to facilitate screwing the valve seat into and out of said threaded aperture in the valve body;
wherein said valve seat has a larger diameter at one end to form a shoulder presenting said valve seat surface around said passage;
wherein the threads of said threaded aperture about said passage are self-locking threads for retaining the valve seat in said threaded aperture of the valve body.

16. The valve according to claim 15, wherein the length of said valve seat in the direction of said longitudinal axis is greater than the diameter of said valve seat.
